(19) United States
(12) Patent Application Publication
(10) Pub. No.: US 2023/0090165 A1
(43) Pub. Date: Mar. 23, 2023

(54) COMPILER ADD-ON FOR CODE, DATA AND EXECUTION FLOWS ATTESTATION IN A SECURE COMPUTING SYSTEM

(71) Applicant: Kameleonsec, Inc., Mountain View, CA (US)

(72) Inventors: Aviram SHEMESH, Haifa (IL); Nissan ALONI, Zoran (IL); Ido NAISHTEIN, Mishmarot (IL)

(73) Assignee: Kameleonsec, Inc., Mountain View, CA (US)

(21) Appl. No.: 17/481,669

(22) Filed: Sep. 22, 2021

(51) Int. Cl. G06F 21/12; H04L 9/32

(52) U.S. Cl. CPC G06F 21/12; H04L 9/3239; G06F 8/41

(57) ABSTRACT

A method and system for execution of a compiler add-on for securing code are provided. The method includes receiving from a compiler a code in machine language; generating at least one validator code for protection of the received code; generating at least one execution proof for protection of at least one execution flow of the received code; embedding the at least validator code and at least one execution proof into the received code to create a protected code; and storing the protected code in a storage.

### TECHNICAL FIELD

The present disclosure relates generally to system security, and more particularly to a compiler used within a computing system to generate protections within its compiled code.

### BACKGROUND

As computer systems become increasingly complex and interconnected, the need for increased security is paramount. In response to modern computer networks growing increasingly sophisticated, potential attackers diligently search for security lapses to breach safety measures present in various systems. The established protocols of running anti-virus applications and inserting firewalls between an internal system and, for example, the internet, no longer offer sufficient protection on their own. One challenge presented by running software is ensuring that a perpetrator cannot gain access to the processes executing under the same environment or operating system. Such access may allow malware to be inserted, may allow confidential information about the software to be exposed, and the like.

It has been long-established that current software solutions are susceptible to tempering by any other code or device that may have access to the system memory or disk storage. This may be achieved by altering the code, data, or execution flow of the attacked program. Operating under the same host system, any program with the same permissions level or higher, can interfere or change the running code. For example, rootkits are a strain of malware, i.e., malicious software, designed to enable access to a computer or an area of its software that it should not otherwise be permitted to access. Rootkits are known for their design that allows them to change the operating system code and data. It is capable of hiding itself, or the perpetrator malware files, by subverting the host system code. This is done at any software level and on any of the different system permission rings. Subverting software code is achievable on both disk (also referred to as static patching, where the software binary information is altered prior to execution on the system) and memory (also referred to as dynamic patching, from where the software binary code executes on the system CPU, the attacker changing it during its execution). In either case the effects of code alteration are affecting the system when executed.

One way that existing solutions attempt to address these issues is to try and identify these cases by using a variety of system and software solutions. These attempt to identify the perpetrator and eliminate it in various ways, during execution time or by passive scanning mechanisms operative post breach time, designed to avoid farther system compromise. However, it is necessary to identify such malware, update the systems accordingly and then it may be possible to identify a particular type of attack. In more modern systems various artificial intelligence (AI) solutions are employed. However, AI-based solutions, much like their predecessors, take time to identify the perpetrator's characteristics before they can effectively eradicate its impact on the attacked system.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for execution of a compiler add-on for securing code, comprising: receiving from a compiler a code in machine language; generating at least one validator code for protection of the received code; generating at least one execution proof for protection of at least one execution flow of the received code; embedding the at least validator code and at least one execution proof into the received code to create a protected code; and storing the protected code in a storage.

Certain embodiments disclosed herein also include a compiler system comprises a processing circuitry; a memory connected to the processing circuitry, the memory containing therein a compiler code and a compiler add-on code, wherein the compiler is configured to compile a code received in a first language into a machine code of a target system, and wherein the compiler add-on is adapted to secure the code generated by the compiler; and a storage communicatively connected to the processing circuitry, wherein the storage contains therein the code in the first language; such that upon execution of the compiler add-on by the processing circuitry the compiler system is configured to: receive from the compiler the code in the machine language; generate one or more validator codes for protection of at least one of code text and code data of the received code; generate at least one execution proof for protection of at least one execution flow of the received code; embed the at least one validator code and at least one execution proof into the received code to create a protected code; and store the protected code in a storage.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a block diagram illustrating a compiler with a compiler add-on to provide for means of attestation of code, data and process flows according to an embodiment.

FIG. 2 is a block diagram illustrating a compiler system according to an embodiment.

FIG. 3 is a flowchart of the operation of the compiler add-on according to an embodiment.

FIG. 4 is an example of protected compiled code read and write validators and read and XOR validator as outputted by the compiler add-on according to an embodiment.

FIG. 5 shows a full compiler protection flow according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments provide a compiler with a compiler add-on, where the compiler add-on is adapted to provide code, data and execution flow attestation in the context of a secure computing system. Accordingly, upon the generation of a compiled code, i.e., generation of assembly code of a software program by the compiler, the compiler add-on provides additional code that is targeted to provide additional security level. By adding validators which are program units that alert of potential discrepancies between expected and actual performance, as well as execution proofs, the secured compiled code delivers maximum protection during runtime. The series of protections added by the compiler add-on complement each other and thus prevent exploitation of weaknesses or code patches if and when they exist. As a result, a binary compiled with this add-on can facilitate a complete trusted computing base (TCB) code instance even if running inside a completely hostile or compromised system.

The code provided by the compiler, after the additions provided by the compiler add-on, all for real time attestation of the machine language code executed by a processor. In an embodiment, it is adapted to validate data, code, and execution flows using a third-party device or application running on the same or different system or device. The agility of the solution provided, allows for safeguarding and authenticating any code compiled by such compiler add-on, on different computing platforms, i.e., being agnostic to the underlining hardware and operating system.

It should be appreciated that systems that do not have a TCB as part of their design do not provide security of their own. By applying the teachings herein, it is possible to overcome the deficiencies of the prior art, in particular the need to rely on current big and vulnerable kernels and create a running TCB even within a compromised system. These technical advantages and other improvement will become apparent from the descriptions provided herein in greater detail.

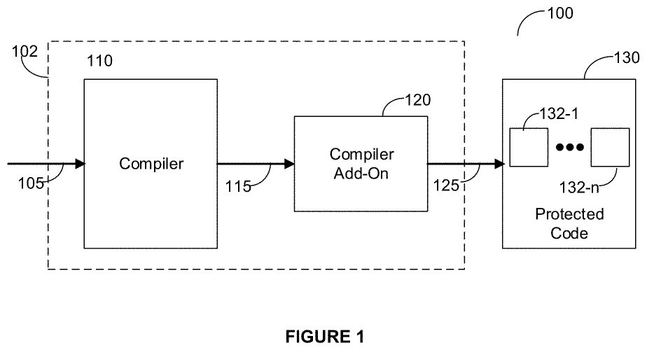

FIG. 1 is an example block diagram illustrating a compiler 110 with a compiler add-on 120 designed according to an embodiment. The compiler add-on 120 provide for means of attestation of code, data and process flows. The compiler 110, is a computer program adapted to translate a computer code in a particular high-level programming language into another language. For this particular case the translation is into the assembly language of a target hardware component, or the processing platform, on which the machine language that corresponds to the assembly language executes. So, the compiler 110 is configured to receive a program 105 written in a high-level language, for example C, C++, Java, etc. According to an embodiment, the compiler 110 is configured to translate the received program 105 into a respective assembly language program 115 which is then fed into the compiler add-on 120.

The compiler add-on 120, and as further explained herein, is configured to provide additional protections that allow attestation of the code, data and executions flows using an independent entity to provide this attestation. The compiler add-on 120 therefore is configured to add certain protections and execution proofs to the assembly code 115 provided to the compiler add-on 120, and as further explained herein. The secured code 130 now contains in addition to the original code 115 one or more protections 132, e.g., protections and execution proofs, for example hooks 132-1 through 132-n, where ‘n’ is an integer greater than or equal to ‘1’, that enable the attestation of code, data and execution flows when the protected code 130 executes on the target hardware. The compiler 110 together with the compiler add-on 120 are referred together as the modified compiler 102.

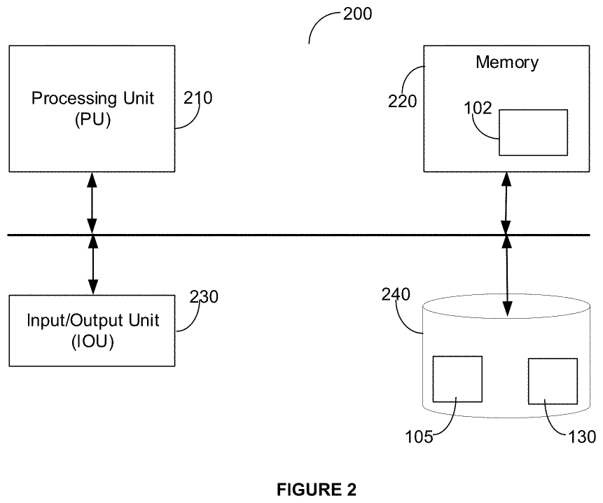

FIG. 2 is an example block diagram illustrating a compiler system 200 according to an embodiment. The compiler system 200 is configured to execute the modified compiler 102 on the compiler system 200 to generate and store the secured executable code 130 of a program 105. The compiler system 200 comprises a processing circuitry 210 that is communicatively connected to a memory 220. The memory 220 may comprise of volatile memory, such as random-access memory (RAM) and the like, as well as non-volatile memory, such as Flash memory, read only memory (ROM) and the like. The processing circuitry 230 is further communicatively connected to an input/output unit (IOU) 230. The IOU 230 provides interface connectivity to various peripherals such as displays, keyboards, input devices, output devices, as well as network connectivity. The processing circuitry 210 is further communicatively connected to a storage 240, for example, but not by way of limitation, hard disk drives (HDDs) or solid-state drives (SSDs) and the like.

The memory 220 is configured to store software. Software shall be construed broadly to mean any type of instructions, whether referred to as software, firmware, middleware, microcode, hardware description language, or otherwise. Instructions may include code, e.g., in source code format, binary code format, executable code format, or any other suitable format of code. The instructions, when executed by processing circuitry 610, cause processing circuitry 610 to perform the various processes described herein. Specifically, when executed by processing circuitry 610, cause processing circuitry 610 to perform the various of the compiler add-on.

The processing circuitry 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The storage 240 may have stored therein the program 105 and the secured code 130, as further explained herein. The instructions that include the modified compiler 102 execute on the processing circuitry 210 thereby performing the teachings herein, and more particularly, providing the protections into the assembly language program 115 of the received program 105 according to the principles shown herein. It should be understood that the embodiments described herein are not limited to the specific architecture illustrated in FIG. 2, and other architectures may be equally used without departing from the scope of the disclosed embodiments.

The compiler add-on 120 provides additional protections to the code when it is compiled by implementation of several major protection mechanisms. First, the code 115, i.e., the text section, remains the same as it was compiled by the complier, for example compiler 110. Second, data sections containing data, parameters, and information that the code uses to properly operate, should always remain intact and as expected. Lastly, the execution graph, i.e., the way the code is executed, is pre-determined by the programmer, and hence, any protection shall make sure that the code does not divert from the normal flows that were determined at compilation time by the compiler 110.

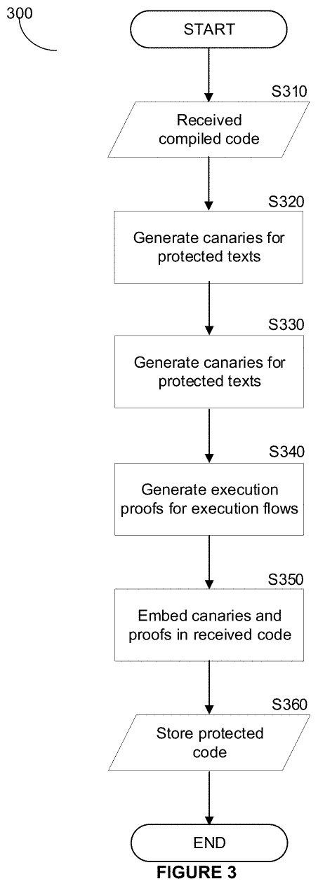

FIG. 3 is an example flowchart 300 of the operation of the compiler add-on according to an embodiment. The flowchart 300 is discussed with reference to the elements shown in FIG. 1.

At S310, a compiled code, for example compiled code 115 which is the output of the compiler 110 is received. At S320 one or more validators are generated for validation of protected text of the received compiled code. Validators are entities, physical or virtual, which provide early warning of a developing adverse situation. The early warning allows to take preventive action before damage is made. The received code 115 is loaded to memory may be represented as one or more text sections (text code portions) within the system memory of the target hardware. The code 115 may therefore be protected by a simple bit-to-bit compression algorithm along with a hash (e.g., SHA-256) calculated at compilation time by the compiler add-on 120. The hashing can be performed on portions of the protected text and then at execution of each protected section the hash can be checked making it impossible to patch the protected area code or change it in a way that results with rouge code for execution in place of the original code. The protection provided in S220 pertains to protection and validation of sections that do not change during execution, namely, the code (with the exception of self-modifying code) and read-only (RO) data. By using the one or more validators devised for this kind of protection it is impossible to patch the protected area code or change it in a way that results with rouge code execution in place of the original code.

At S330, one or more validators are generated for validation of protected data of the data that is provided alongside of the program code. In fact, the data provided may itself be partitioned into various data sections and each such section includes the parameters and resources the program may use during execution. Typically, global parameters are stored inside the data section (i.e., the process heap) and are accessible throughout the program execution. This is different from the local function parameters which are stored transiently on the protected thread stack and last only throughout the execution period of the local function. In an embodiment boundary check validators may be added to check for renegade value resulting from attempts to temper with the data. For example, if the range of a particular parameter is [0 . . . 100] then if a value is found that is outside this range boundary check validator will constantly validate that range throughout the entire protected program execution time. In another embodiment, an underflow/overflow validator may be used to alert of such situations. The compiler add-on is adapted to automatically detect parameters' definitions across the program to be protected and during compilation it adds an 8-byte number (i.e., 2⁶⁴ unique options) before and after each parameter in memory. During execution such validators will warn of such underflow/overflow occurrence and stop execution. It should be understood that an underflow validator or an overflow validator may also be types of validators used according to embodiments.

At S340 one or more validators are generated for validation of protected execution flows. In this case these set of protections are adapted to prove that the protected code is not only intact (as attested by the text and data protections) but also the actual expected flow of execution. It should be appreciated that a protected code could be completely loaded into a system memory intact and unharmed, but easily disabled by, for example, suspending its operating system process or by executing a return-oriented programming (ROP) attack on the running code, subverting the protected code into executing the code but at the wrong order. As a result, protected code will function entirely different than originally intended by a programmer of the compiled code. To make sure the code not only runs at all times but also as intended, the add-on compiler, according to an embodiment, provides a number of execution proofs. The execution proofs include a) read and write execution proof [rwREF]; b) write and XOR execution proof [xREF]; and, c) write and random execution proof [uREF].

The rwREF is activated by the programmer of the code 105 providing hints for guarding a specific area of code expected to always run in a pregiven time frame. For example, but not by way of limitation, for a function with an infinite execution loop, the programmer should mark such function and all its internal function calls as protected functions. According to an embodiment, the compiler add-on 120 automatically inserts a sequence of assembly commands that asserts zero 64b long values to a predetermined location at the data section of the protected binary code 130. For each protected function inside the protected code there will be three unique values: 1) data location to read a 64b value (the read value); 2) code location to write a 64b value (the write value); and, 3) time interval for checking the read value (the time to check read). By providing these means of protection, during execution of the protected program the respective validators will provide the necessary proofs or alerts as may be required.

The xREF execution proof can be combined with the rwREF execution proof or be used as a standalone validation. According to an embodiment, when used in combination with the rwREF execution proof the compiler add-on 120 inserts a sequence of assembly commands that XOR the 64-bit long value which was assigned to the rwREF execution proof. The XOR key value may be a randomly generated number by the protected code. When used as a standalone execution proof the five assembly commands can be located anywhere inside the protected function similarly to the case of the rwREF execution proof. The inserted protection acts to: randomly write random value at write value (XOR command) or read value (data location); wait for a predetermined time interval (time to check read) to lapse; and, validate that the XOR expected result from the write value and the read value that appears at the predetermined read value location. This is repeated as necessary.

The uREF is used to change specific code behavior inside the protected code. That is, polymorphing the code and/or data in such a way that does not change the semantic execution flow of the code, yet results in data, and operating system changes, that are apparent during execution of the protected code. For example, but not by way of limitation, a specific process parameter may be changed causing the code to reassign it when used later. By doing so, it is possible to introduce a random set of proofs that are executed randomly and are not visible to or copied by an attacker.

It should be further appreciated that the execution proofs may be used as code coverage score. When used, the code coverage score enables a programmer to find out which code snippets are executing and in which pace per protected function. This further enables refinement and tuning of programming hints provided to the compiler and the compiler add-on, to assist in the compilation process of the provided program 105.

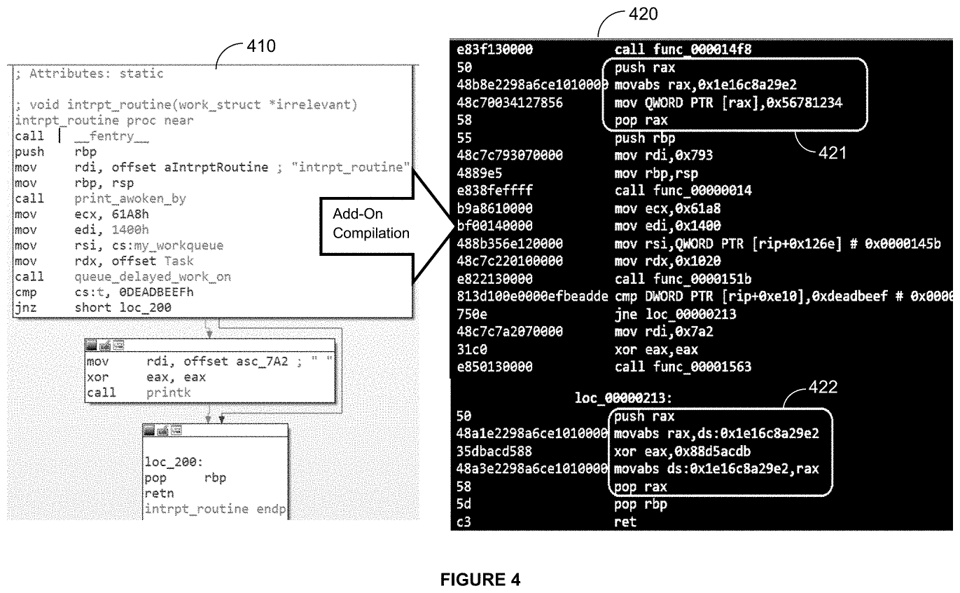

At S350 the generated validators and proofs provided by S320, S330 and S350 are embed in the code, so that the protected code is generated. This is further shown by way of example with respect of FIG. 4. At S360 the protected code is stored, for example in storage 340.

FIG. 4 is an example 400 of protected compiled code read and write validator and read and XOR validator as outputted by the compiler add-on according to an embodiment. A compiled code 410 is provided in code appropriate for the target hardware. The compiler add-on, for example compiler add-on 120, performs the process described in FIG. 3, and embeds into the received compiled code a read and write validator 422 and a read and XOR validator 424, resulting in a protected compiled code 420.

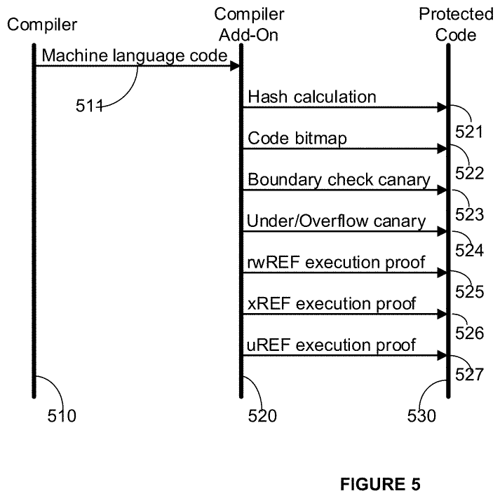

FIG. 5 is an example of a full compiler protection flow 500 according to an embodiment. The communication flow begins with a compiler 510 adapted to accept a program in one language, typically a high-level language, and compile it into the machine language code 511 of a target hardware. According to an embodiment, a compiler add-on 520 receives the code 511 and performs the protections described herein in greater detail. Specifically, the compiler add-on flow comprises generation of one or more hash calculation 521, code bitmap 522, boundary check validator 523, underflow or overflow validator 524, rwREF execution proof 525, xREF execution proof 526, and a uREF execution proof. The generated values, validators and execution proofs are integrated within the received code 511 resulting in the protected code 530.

It should be noted that any software or code discussed with reference to the disclosed embodiments shall be construed broadly to mean any type of instructions, whether referred to as software, firmware, middleware, microcode, hardware description language, or otherwise. Instructions may include code, e.g., in source code format, binary code format, executable code format, or any other suitable format of code.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

The algorithms and displays presented herein are not inherently related to any particular computer or other apparatus. Various general-purpose systems may be used with programs in accordance with the teachings herein, or it may prove convenient to construct more specialized apparatus to perform the required method. The required structure for a variety of these systems will appear as set forth in the description above. In addition, the disclosed embodiments are not described with reference to any particular programming language. It will be appreciated that a variety of programming languages may be used to implement the teachings of the invention as described herein.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for execution of a compiler add-on for securing code, comprising:
receiving from a compiler a code in machine language;
generating at least one validator code for protection of the received code;
generating at least one execution proof for protection of at least one execution flow of the received code;
embedding the at least validator code and at least one execution proof into the received code to create a protected code; and
storing the protected code in a storage.

2. The method of claim 1, wherein generating protection of the code includes generating protection for code text portions of the received code by:
compressing the code text portions; and
generating a hash code respective of the code text portions.

3. The method of claim 1, wherein protecting at least code text portions further comprises:
dividing each text code portion into a plurality of code text sections;
compressing each of the plurality of code text sections; and
generating a hash code respective of each of the code text sections.

4. The method of claim 1, wherein the at least one validator code is a boundary check validator.

5. The method of claim 1, wherein the at least one validator code is an underflow/overflow validator.

6. The method of claim 1, wherein the at least one execution proof is a read and write (rwREF) execution proof.

7. The method of claim 1, wherein the at least one execution proof is a write and XOR (xREF) execution proof.

8. The method of claim 1, wherein the at least one execution proof is a write and random (uREF) execution proof.

9. The method of claim 1, further comprising:
determining a code coverage score for the protected code based on the at least one execution proofs.

10. A compiler system, comprising:
a processing circuitry;
a memory connected to the processing circuitry, the memory containing therein a compiler code and a compiler add-on code, wherein the compiler is configured to compile a code received in a first language into a machine code of a target system, and wherein the compiler add-on is adapted to secure the code generated by the compiler; and
a storage communicatively connected to the processing circuitry, wherein the storage contains therein the code in the first language;
such that upon execution of the compiler add-on by the processing circuitry the compiler system is configured to:
receive from the compiler the code in the machine language;
generate one or more validator codes for protection of at least one of code text and code data of the received code;
generate at least one execution proof for protection of at least one execution flow of the received code;
embed the at least one validator code and at least one execution proof into the received code to create a protected code; and
store the protected code in a storage.

11. The compiler system of claim 1, wherein the system is further configured to:
compress the code text; and
generate of a hash code respective of the code text.

12. The compiler system of claim 1, wherein the system is further configured to:
divide the text code into a plurality of code text sections;
compress each of the code text sections; and
generate of a hash code respective of each of the code text sections.

13. The compiler system of claim 1, wherein the one or more validator codes is a boundary check validator.

14. The compiler system of claim 1, wherein the at least one validator code is any one of: an underflow validator, an overflow validator, and an underflow/overflow validator.

15. The compiler system of claim 1, wherein the at least one execution proof is a read and write (rwREF) execution proof.

16. The compiler system of claim 1, wherein the at least one execution proof is a write and XOR (xREF) execution proof.

17. The compiler system of claim 1, wherein the at least one execution proof is a write and random (uREF) execution proof.

18. The compiler system of claim 1, wherein the system is further configured to:
determine of a code coverage score for the protected code based on the one execution proof.

19. A non-transitory computer readable medium having stored thereon instructions for causing a processing circuitry to execute a process for execution of a compiler add-on for securing code, the process comprising:
receiving from a compiler a code in machine language;
generating at least one validator code for protection of the received code;
generating at least one execution proof for protection of at least one execution flow of the received code;
embedding the at least validator code and at least one execution proof into the received code to create a protected code; and
storing the protected code in a storage.
